(19) United States
(12) Patent Application Publication
(10) Pub. No.: US 2026/0188774 A1
(43) Pub. Date: Jul. 2, 2026

(54) LASER-ASSISTED STRIPPING OF BATTERY PACKS

(71) Applicant: TRUMPF LASER- UND SYSTEMTECHNIK SE, Ditzingen (DE)

(72) Inventors: Oliver BOCKSROCKER, Sachsenheim (DE); Mauritz MÖLLER, Korntal (DE); Max RETTENMEIER, Jagstzell (DE)

(21) Appl. No.: 19/547,722

(22) Filed: Feb. 24, 2026

Related U.S. Application Data
(63) Continuation of application No. PCT/EP2024/070704, filed on Jul. 22, 2024.

(30) Foreign Application Priority Data
Aug. 31, 2023 (DE) 10 2023 123 497.8
Oct. 19, 2023 (DE) 10 2023 128 787.7

(51) Int. Cl. H01M 10/54; B23K 26/03; B23K 26/046; B23K 26/12; B23K 26/14; B23K 26/38; B23K 101/36; B23K 103/04; B23K 103/10

(52) U.S. Cl. CPC H01M 10/54; B23K 26/032; B23K 26/048; B23K 26/123; B23K 26/1462; B23K 26/38; B23K 2101/36; B23K 2103/05; B23K 2103/10

(57) ABSTRACT

A laser cutting method for cutting open a battery assembly is provided. The battery assembly includes a cell assembly and a housing surrounding the cell assembly. The housing includes a first housing shell and a second housing shell firmly connected to one another along a connecting region on an outer circumference of the housing. The method includes creating a cut gap in the first housing shell along a predefined cutting contour by using a laser beam. The predefined cutting contour extends laterally outside the cell assembly and laterally inside the connecting region.

### CROSS REFERENCE TO RELATED APPLICATIONS

This application is a continuation of International Application No. PCT/EP2024/070704 (WO 2025/045454A 1 ), filed on Jul. 22, 2024, and claims benefit to German Patent Application No. DE 10 2023 123 497.8, filed on Aug. 31, 2023, and to German Patent Application No. DE 10 2023 128 787.7, filed on Oct. 19, 2023. The aforementioned applications are hereby incorporated by reference herein.

### FIELD

Embodiments of the present invention relate to the field of batteries, such as those used for operating electric motors in electric vehicles. In particular, embodiments of the present invention relate to a technique for disassembling a battery assembly by means of laser cutting.

### BACKGROUND

The structure of battery assemblies, also known as battery packs, is described below in a simplified manner based on FIG. 1a. The exploded view according to FIG. 1a shows a battery assembly 10, in the interior of which a cell assembly 12 having a plurality of cell modules 122 is arranged as a core component, which in turn comprise one or more electrically interconnected battery cells (not shown in FIG. 1a). The battery assembly 10 comprises further functional components, such as a controller (also referred to as BMS or Battery Management System), an interface to an electrical consumer, cooling elements, and others, which are shown here only by way of example and without their own reference symbols in the figures. The interior of the battery assembly is shielded from the outside by two housing shells 142, 144, which are firmly connected to one another (e.g., screwed and/or glued), and which can also be referred to as upper and lower trough parts, and together form a housing 14 of the battery assembly 10.

In order for the components of a battery assembly 10 to be reused in a resource-saving manner after the end of its life cycle, the battery assembly 10 must be at least partially disassembled or dismantled. One of the first steps of disassembling or dismantling a battery assembly 10 is to remove or at least open the housing 14 in order to access the core components of the battery assembly 10—in particular the battery cells contained in the cell assembly 12, i.e., the valuable active material of the battery assembly 10.

Thus far, the housing shells 142, 144 of housing 14 have usually been manually disassembled by a person. This manual process, which usually requires loosening a screw flange and/or adhesive bonds (and/or other connections such as rivet connections, weld connections, etc.) between the housing shells 142, 144, is very complex and requires that the battery cells inside the battery assembly 10 are completely discharged in order to eliminate the risk of uncontrolled discharge (e.g., electric shock, short circuit, etc.) or thermal runaway of the battery cells during disassembly. Those skilled in the art also refer to this as deep discharge of the battery cells. The use of (partially) automated screwdriving technology or the use of machining processes to loosen or separate the joining connections between the housing shells 142, 144, which are usually made of aluminum or iron-based materials, contributes only marginally to an increase in efficiency in the disassembly of the battery assemblies.

### SUMMARY

Embodiments of the present invention provide a laser cutting method for cutting open a battery assembly. The battery assembly includes a cell assembly and a housing surrounding the cell assembly. The housing includes a first housing shell and a second housing shell firmly connected to one another along a connecting region on an outer circumference of the housing. The method includes creating a cut gap in the first housing shell along a predefined cutting contour by using a laser beam. The predefined cutting contour extends laterally outside the cell assembly and laterally inside the connecting region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows an exploded view of a battery assembly;

FIG. 1b shows a schematic view of a section of a battery assembly in which two housing shells of the battery housing are connected to one another by a screw connection;

FIG. 2a shows a schematic top view of a battery assembly to illustrate a laser cutting method according to embodiments of the invention; and

FIG. 2b shows a schematic sectional view of the battery assembly according to FIG. 2a, according to some embodiments.

### DETAILED DESCRIPTION

Embodiments of the present invention can improve the prior art in relation to the disassembly of battery assemblies. In particular, it should be possible to open the housing of the battery assembly flexibly and efficiently as part of an automated process, regardless of the condition and type of connection of the housing shells, without damaging the battery cells.

According to embodiments of the invention, a laser cutting method is provided for cutting open a battery assembly. The battery assembly comprises a cell assembly and a housing or battery housing surrounding the cell assembly, which forms an enclosure for the battery assembly. The housing comprises a first housing shell and a second housing shell, which are firmly connected to one another along an outer circumference of the housing (for example by a screw, rivet, adhesive and/or weld connection). In a simple version of the battery assembly, the housing shells can also be referred to as half-shells. The battery assembly can, for example, have a so-called cell-to-pack battery pack architecture. This means that individual battery cells are directly installed (e.g., foamed) inside a battery pack (=battery assembly). Alternatively, the battery assembly can also have a so-called cell-to-module or module-to-pack architecture, in which a plurality of battery cells are packed in one cell module. If the battery assembly comprises multiple cell modules, these are usually electrically connected to one another in order to combine the capacity of all battery cells. In addition to those mentioned, the battery assembly can also have other pack architectures. For example, there are also so-called cell-to-chassis architectures, in which the battery cells are directly integrated into the vehicle structure. In this case, the battery assembly according to embodiments of the invention could be considered part of the vehicle and the battery housing as part of the vehicle structure. The housing shells, or at least one of the housing shells, can be made of a metallic material, in particular aluminum-based (in particular 3000 series or 5000 series aluminum) or iron-based (in particular stainless steel). The thickness of a metallic housing shell can, for example, range from 0.5 mm to 3 mm. Alternatively, at least one of the housing shells can be made of a plastic or a fiber-reinforced composite material (CFRP). Preferably, the housing shells have the same or a similar material composition. Examples of battery assemblies according to the present disclosure comprise various (rechargeable) batteries from the field of eMobility, for example for use in cars, trucks or commercial vehicles (BEV, PHEV, MHEV or HEV), forklifts, eBikes, ships, aircraft, drones, etc., as well as in other areas, for example for building power supply or grid stabilization or in power tools (garden tools, cordless screwdrivers, etc.).

According to embodiments of the invention, a cut gap is created in the first housing shell along a predefined cutting contour by means of the laser cutting method, wherein the cutting contour extends laterally outside the cell assembly and laterally inside a connecting region along which the housing shells are connected to one another. The laser cutting method can preferably be carried out using a solid-state laser (in particular fiber lasers (such as, for example, from the applicant's TruFiber 500-2000 series) or disk lasers (such as, for example, from the TruDisk 2000-8000 series or TruDisk 3001-24001 series)) as a single-mode laser or a multi-mode laser. The laser power can, for example, be in the range of 500 W to 24 kW, preferably in the range of 2 kW to 8 kW.

The wording “laterally outside” and “laterally inside” are to be understood as meaning that the cutting contour extends in a top view of the battery assembly between the battery assembly and the connecting region (which can be formed, for example, by a screw flange). The top view of the battery assembly is taken from a direction (z direction) perpendicular to an x-y plane of a Cartesian coordinate system, which can be used to describe the spatial dimensions of the battery assembly.

The arrangement of the cutting contour is intended to ensure that the laser beam used for laser cutting is not directed at the cell assembly inside the battery assembly and consequently does not critically damage it. At the same time, the connection of the housing shells should be avoided by creating the cut inside the connecting region in only one housing shell.

The inventors have recognized that a laser cutting method according to embodiments of the present invention is suitable for disassembling battery assemblies. This is not a given because laser cutting uses very high energies and the workpiece being machined is partially heated very intensely. In contrast, for the battery cells of a battery assembly, a heat input of 60° C. or higher can be critical (risk of ignition). It has been shown that laser cutting, due to its flexible applicability and high degree of automation, can significantly simplify the process of disassembling battery assemblies. Firstly, the speed of disassembly is significantly increased compared to a manual process. By selectively separating only one housing shell, the process can be carried out regardless of the type and/or nature of the connection between the housing shells (welded connection, screwed connection, riveted connection, adhesive connection, etc.) and offers great flexibility. When using a (numerically controlled) laser cutting method according to embodiments of the invention, discharging the battery cells is generally not necessary, since the high precision of the method makes it highly likely that critical damage or interference with the battery cells inside the battery assembly, which could lead to uncontrolled discharge or thermal runaway of the battery cells, can be excluded. The laser cutting method takes place in a safe environment and is preferably fully automated. This also reduces the risk of personal injury during the disassembly of the battery assemblies.

Compared to conventional disassembly methods, the laser cutting method according to embodiments of the invention offers the following additional advantages:
the disassembly or opening of the battery housing takes place in a cutting process which can remove either at least two screw connections (or rivet connections) or a continuous joining connection (glued, welded) in one process step;
a plurality of joining and packing variants of a battery assembly can be processed on one system without changing tools;
there is no dependency on the condition of the joint between the housing shells. This condition can be affected by environmental influences over many years of use. Therefore, precise knowledge about impairments of the battery pack is usually not necessary;
the process can be fully automated, without manual intervention;
by means of the flexible, laser-assisted (3D) method, battery packs of different designs can be cut open on one system;
by only having to cut (or separate) one half of the housing shell, productivity during disassembly is increased;
compared to other thermal cutting methods (e.g., plasma cutting), laser cutting results in a significantly lower heat input into the workpiece;
in contrast to machining methods (e.g., milling), no chips are produced that could contaminate the interior of the battery assembly;
no foreign substances are introduced, for example via coolants (in particular cooling lubricants) or other operating materials that are required in other methods.

According to a preferred variant of the laser cutting method, an optical axis of the laser beam used for the laser cutting method has a distance of at least 0.5 mm, preferably at least 1 mm, from the cell assembly at all times during the laser cutting method (i.e., when the laser beam is switched on). In other words, the laser beam used for cutting always maintains the predefined minimum distance to the cell assembly, or to the battery cells arranged inside it. In this way, critical heat input from laser radiation during the cutting process can be significantly minimized. The heat input is particularly critical when a battery cell, or a section of a battery cell, is heated to a temperature of 60° C. or higher, or (in particular critical) to 100° C. or higher.

According to one variant, the laser cutting method can be implemented as a laser fusion cutting method. In this case, an inert cutting gas can be used to expel the molten material and to shield the process zone from unwanted reaction with the surrounding atmosphere (in particular with atmospheric oxygen). Nitrogen, in particular, can be used as an inert cutting gas. Furthermore, the use of an inert cutting gas can prevent the risk of ignition of adjacent plastics (e.g., foams or plastic components) inside the battery assembly.

According to an alternative variant, the laser cutting method can be implemented as a laser flame cutting method, using oxygen or an oxygen-containing gas mixture as the cutting gas. This method variant can be particularly advantageous when cutting an iron-containing housing shell, in particular one with a relatively large wall thickness.

In a laser fusion or laser flame cutting process, the laser cutting method is carried out with a laser cutting system, which preferably has fixed optics by means of which the laser beam together with the cutting gas jet is directed onto the first housing shell via a cutting nozzle. Furthermore, a laser beam can be used to carry out the method, which has a central core beam and a ring-shaped beam surrounding the core beam. This beam shape can be implemented using the well-known 2-in-1 technology, in which the laser beam is guided into the processing optics via a 2-in-1 optical fiber, enabling both an increase in cutting speed and an improvement in the cut edges.

For example, a cutting nozzle can be a nozzle where the inner contour has the shape of a Laval nozzle. Using a Laval nozzle as a cutting nozzle can achieve comparatively larger working distances with comparatively lower cutting gas consumption.

According to one variant of the laser cutting method, the processing beam, comprising a laser beam and a cutting gas jet, can be directed at an angle to a surface of the first housing shell, in particular to the x-y plane along which the cell assembly is arranged, such that the laser beam is directed in the beam propagation direction in a direction away (relative to the z direction) from the cell assembly. The angle relative to the x-y plane can be in a range between 90° (perpendicular beam incidence—simple arrangement that can be implemented without a swiveling laser cutting head) and 45° (inclusive). The angled arrangement of the processing beam means that the molten material, which is expelled downwards from the cut gap during laser fusion cutting or laser flame cutting, can be kept away from the cell assembly. Contamination of the important, central components of the battery assembly, in particular contamination (and heating) of the cell assembly by the expelled cutting slag, can therefore be avoided.

According to another alternative, the laser cutting method can also be implemented as a laser sublimation cutting method. In laser sublimation cutting, the workpiece material is vaporized, resulting in little or no melt being expelled from the cut gap due to the vapor pressure. Consequently, no (or only minor) impurities are generated inside the battery assembly.

The laser cutting method according to embodiments of the invention can further comprise optical observation of the laser cutting method in order to detect the actual course of the cut gap. Furthermore, the method can comprise adjusting the cutting parameters of the laser cutting method if the course of the cut gap deviates from the predefined cutting contour by at least a predefined minimum value in order to correlate the cut gap with the cutting contour. By compensating for the determined tolerances, the precision of the cutting process can be increased. Waste can consequently be reduced.

According to a further preferred variant, the cut gap produced during the laser cutting method is a closed cut gap, such that a cut-out part of the first housing shell is completely separated from a surrounding residual part of the housing shell. In other words, the cutting contour can be a closed contour. Alternatively, the cutting contour or the cut gap can also be designed to be open (for example, essentially a U-shaped cutting contour), so that the cut-out part remains connected to the rest of the housing shell after the cutting process has been carried out. The contour can also be a closed contour, wherein the laser cutting parameters are set so that at least one microjoint or nanojoint remains in the resulting cut gap along the cutting contour, holding the cut-out part in the surrounding residual part. Technologies for generating microjoints or nanojoints using laser cutting were introduced and publicly documented by the applicant several years ago. The cut can also be divided into a plurality of sub-segments to simplify the later removal of the cut-out part, if necessary. Additional openings can also be made, for example, in the cut-out part or adjacent to the cut-out part in the remaining part, to facilitate access when removing the cut-out part.

The method can furthermore comprise the following steps: measuring, during the laser cutting method, a distance between a cutting nozzle used for the laser cutting method and the surface of the first housing shell; and adapting the preset cutting parameters of the cutting process based on the measured distance. By measuring and, if necessary, adapting the working distance of the cutting nozzle (e.g., capacitively, using an OCT measuring method or by means of laser triangulation), the contour accuracy and thus the precision in laser cutting can be increased.

According to embodiments of the invention, a device for laser cutting a battery assembly is also provided. The device comprises at least: a workpiece support for supporting the battery assembly during the cutting process; a laser beam source for providing a laser beam; a laser processing head for focusing the laser beam in the direction of the battery assembly; and a control unit designed to actuate the device to carry out a laser cutting method according to one of the variants described above. If the laser cutting method is implemented as a laser fusion or laser flame cutting process, the device then further comprises at least one corresponding cutting gas supply. In particular, the device can be designed as a 3D laser cutting system, by means of which the processing head can be guided not only vertically (see 2D laser flatbed system), but also at an angle.

In the following drawings, identical or functionally identical elements are provided with the same reference signs in the figures.

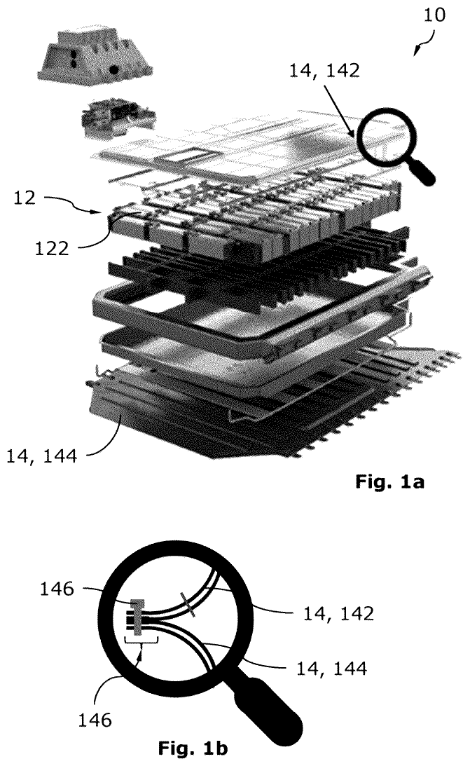

The battery assembly according to FIG. 1a has already been described above in connection with the prior art. Reference is made to the corresponding description.

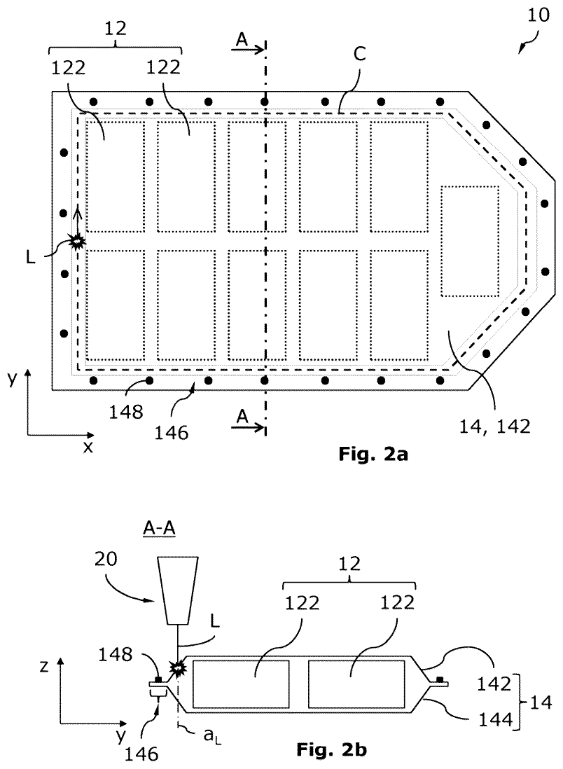

FIG. 1b schematically shows an enlarged section at the edge of the battery housing 14. In this peripheral area, the first (upper) housing shell 142 and the second (lower) housing shell 144 are connected to one another in a connecting region 146 by a screw connection. In the first housing shell 142, a possible positioning of a laser cut according to a laser cutting method according to embodiments of the invention is indicated by a line. FIGS. 2a and 2b describe the laser cutting method according to embodiments of the invention in more detail.

FIG. 2a shows a battery assembly 10 in a top view, wherein the drawing plane in the top view corresponds to the x-y plane of a Cartesian coordinate system. The battery assembly 10 shows a cell assembly 12 having a plurality of cell modules 122, which in turn house a plurality of battery cells (not shown in the figures). In other words, the depicted battery assembly 10 has a cell-to-module or module-to-pack battery architecture. The cell arrangement 10, together with other battery components (not shown in FIGS. 2a and 2b) (see, for example, FIG. 1a), is surrounded by a housing 14. The housing 14 comprises a first housing shell 142 and a second housing shell 144, which are firmly connected to one another along a connecting region 146 on the outer circumference of the housing 14—here by way of an example by means of a screw connection. It goes without saying that in addition to a screw connection, other connection types are also possible, such as rivet connections, adhesive connections, welded connections, or combinations of several connection types. According to embodiments of the invention, the first (in this case the upper) housing shell 142 is cut open along a cutting contour C by means of a laser beam (e.g., in a laser fusion cutting method). As can be clearly seen in the top view, the cutting contour C (here as closed cutting contour C) extends laterally outside the cell assembly 12 and laterally inside the connecting region 146. In this way, the first housing shell 142 is separated without having to loosen the screws 148 of the screw connection and without the cell assembly 12 being critically heated by the laser beam L.

FIG. 2b shows a cross-section through the battery assembly 10 according to FIG. 2a along the section line AA. FIG. 2b also clearly shows that the laser beam L strikes the first housing shell 142 laterally (i.e., in the x and/or y direction) in a region between the connecting region 146 and the cell assembly 12. The optical axis a_{L} of the laser beam L has a minimum distance of at least 0.5 mm, preferably at least 1 mm, from the nearest cell module 122 or from the nearest battery cell (in the case of a cell-to-pack battery architecture) at all times during the laser cutting method (while the laser beam is switched on). FIG. 2b shows a highly schematic representation of a laser cutting head 20 of a laser cutting machine or system, by means of which the laser beam L, possibly together with a cutting gas jet, is directed onto the first housing shell 142 of the battery housing 14.

The following list contains further features and processing parameters, as well as those previously mentioned, that may be relevant for a laser cutting method according to embodiments of the invention for cutting open a battery housing 14 of a battery assembly 10:
the first housing shell 142, preferably both housing shells 142, 144, consist of a sheet material with a thickness in the range of 0.5 mm to 3 mm, in particular based on aluminum (3000 series or 5000 series aluminum) or on iron (in particular stainless steel);
a single-mode laser (e.g., from the applicant's TruFiber 500-2000 series) or a multi-mode laser (e.g., from the TruDisk 2000-8000 or 3001-24001 series) is used as the laser beam source for the laser cutting method, preferably having a laser power in the range of 2 kW to 8 kW;
a fixed optic can preferably be used to carry out the laser cutting method, which is moved over the workpiece (i.e., the first housing shell 142), with the use of cutting gas (conventional laser cutting), with a cutting nozzle and preferably using inert cutting gas to expel the melt;
an optical scanner unit can also be used for remote cutting, with a high intensity being selected to expel the resulting molten material of the first housing shell 142 from the resulting kerf (by means of vapor pressure) through (partial) evaporation (corresponding to the principle of sublimation cutting);
the laser beam L used for the laser cutting method can have a beam parameter product in the range of 0.38 mm*mrad to 16 mm*mrad, in particular of at most 0.6 mm*mrad (single-mode) or of at most 6 mm*mrad (multi-mode), preferably of 4 mm*mrad;
the beam diameter L of the laser beam on the workpiece (i.e., on the surface of the first housing shell 142) can be in the range of 50 μm to 500 μm, in particular in the range of 30 μm to 70 μm (single-mode) and/or (single spot or n-in-1) in the range of 100 μm to 300 μm (multi-mode);
an infrared laser with a wavelength in the range of 800 nm to 1200 nm, in particular with a wavelength of 1030 nm or 1070 nm, can preferably be used as the laser for the laser cutting method;
alternatively, a VIS laser can also be used for the laser cutting method, in particular having a wavelength of 515 nm (green spectral range);
the laser power used for laser cutting can range from 0.5 kW to 24 kW, particularly from 2 kW to 8 kW;
a cutting feed rate in the laser cutting method can range from 10 m/min to 80 m/min (depending on the material thickness), in particular from 20 m/min to 60 m/min;
a cutting optic having a cutting nozzle and cutting gas and having an imaging ratio of 1:1 to 5:1, in particular of 1.5:1 to 2:1, can preferably be used for the laser cutting method;
alternatively, an optical scanner unit (for example, the applicant's scanner optic designated PFO33-2) having an imaging ratio of 1:1 to 5:1, in particular of 1.5:1 to 2:1, can be used;
a camera-based sensor (see the applicant's VisionLine product) can be used for position control during the laser cutting method;
the first housing shell 142 can additionally be prepared for the cutting process, for example by appropriate cleaning processes (e.g., laser cleaning; grinding or other mechanical cleaning; chemical cleaning; etc.). This enables surface contaminants to be removed before the laser cutting method, thus increasing the process reliability of the cutting process.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser cutting method for cutting open a battery assembly, wherein the battery assembly comprises a cell assembly and a housing surrounding the cell assembly, wherein the housing comprises a first housing shell and a second housing shell firmly connected to one another along a connecting region on an outer circumference of the housing, the method comprising:
creating a cut gap in the first housing shell along a predefined cutting contour by using a laser beam, wherein the predefined cutting contour extends laterally outside the cell assembly and laterally inside the connecting region.

2. The method according to claim 1,
wherein an optical axis of the laser beam has a distance of at least 0.5 mm from the cell assembly at all times during the laser cutting method.

3. The method according to claim 1,
wherein the method is implemented as a laser fusion cutting method using an inert cutting gas.

4. The method according to claim 1,
wherein the method is implemented as a laser flame cutting method using oxygen or an oxygen-containing gas mixture as a cutting gas.

5. The method according to claim 3,
wherein a Laval nozzle is used as a cutting nozzle for the laser cutting method.

6. The method according to claim 1,
the method is implemented as a laser sublimation cutting method.

7. The method according to claim 1, further comprising:
optically observing the laser cutting method to detect an actual course of the cut gap; and
adjusting cutting parameters of the laser cutting method if the course of the cut gap deviates from the predefined cutting contour by at least a predefined minimum value, in order to correlate the cut gap with the predefined cutting contour.

8. The method according to claim 1,
wherein the cut gap is a closed cut gap, such that a cut-out part of the first housing shell is completely separated from a surrounding residual part of the first housing shell.

9. The method according to claim 1, further comprising:
measuring, during the laser cutting method, a distance between a cutting nozzle used for the laser cutting method and a surface of the first housing shell; and
adapting cutting parameters of the laser cutting method based on the measured distance.

10. A device for laser cutting a battery assembly, the device comprising:
a workpiece support for supporting the battery assembly;
a laser beam source for providing a laser beam;
a laser processing head for focusing the laser beam in a direction of the battery assembly; and
a control unit configured to actuate the device to carry out a laser cutting method according to claim 1.
